(19) United States
(12) Patent Application Publication
(10) Pub. No.: US 2025/0276806 A1
(43) Pub. Date: Sep. 4, 2025

(54) METHOD FOR DETECTING AN ANOMALY IN A SYSTEM OF AN AIRCRAFT

(71) Applicants: SAFRAN, Paris (FR); SAFRAN NACELLES, Gonfreville-L'Orcher (FR)

(72) Inventors: Mohamed HAMHOUM, Moissy-Cramayel (FR); Daniel FABRE, Moissy-Cramayel (FR); Joffrey BOURLAND, Moissy-Cramayel (FR)

(21) Appl. No.: 18/862,500

(22) PCT Filed: May 5, 2023
(86) PCT No.: PCT/FR2023/000080

§ 371 Date: Nov. 1, 2024

(30) Foreign Application Priority Data
May 10, 2022 (FR) FR2204389

(51) Int. Cl. B64D 45/00; B64D 15/04; G06N 3/0442; G06N 3/0455

(52) U.S. Cl. CPC B64D 45/00; B64D 15/04; G06N 3/0442; G06N 3/0455; B64D 2045/0085

(57) ABSTRACT

A method for detecting an anomaly in a system of an aircraft, including obtaining a current series of measurements of one or more physical quantities of the system, during a time period when the system is in operation; —on the basis of the current series of measurements, providing, by an encoder-decoder, a current reconstructed series; and —comparing the reconstructed current series with the current series of measurements in order to obtain a current series of anomalies. The method further includes computing a current distribution function of the current series of anomalies; —computing an area separating the current distribution function from a reference distribution function; and —comparing the area with a predefined threshold.

### TECHNICAL FIELD OF THE INVENTION

The present invention relates to a method for detecting an anomaly in a system of an aircraft, a corresponding computer program and a monitoring device.

### TECHNICAL BACKGROUND

It is known to use a method for detecting an anomaly in an aircraft device, comprising:
obtaining a series of measurements, called current series of measurements, of one or more physical quantities of the device, during a period of time when the device is functioning;
on the basis of the current series of measurements, a neural network of the encoder/decoder type provides a reconstructed series, called reconstructed current series; and
comparing the reconstructed current series with the current series of measurements in order to obtain a series of anomalies, called current series of anomalies.

More specifically, as is well known, an encoder/decoder 126 comprises an encoder part and a decoder part. The encoder part is configured to perform a compression of the information provided to it as input in order to provide intermediate information that is incomplete as a result of the compression. The decoder part is configured to perform decompression, i.e. to reconstitute the input information from the incomplete intermediate information.

This method is therefore known to be used for an aircraft turbomachine, by comparing each anomaly score in the series of anomalies with a predefined detection threshold. If the anomaly score is above the detection threshold, an anomaly is detected. This detection threshold is defined by maximising an F-score over several series of labelled measurements, some of which are normal and others abnormal.

However, the inventors found that this known method did not work well for certain aircraft devices, such as valves in a channel for conveying hot air to an air inlet lip de-icing system.

It may therefore be desirable to provide a method for detecting an anomaly which avoids at least some of the above-mentioned problems and constraints.

### SUMMARY OF THE INVENTION

A method for detecting an anomaly in an aircraft system is proposed, comprising:
obtaining a series of measurements, called current series of measurements, of one or more physical quantities of the system, during a period of time when the system is functioning;
on the basis of the current series of measurements, providing by an encoder/decoder a reconstructed series, called reconstructed current series; and
comparing the reconstructed current series with the current series of measurements in order to obtain a series of anomalies, called current series of anomalies.
   characterised by:
computing a distribution function, called current distribution function, of the current series of anomalies;
computing an area separating the current distribution function from a reference distribution function; and
comparing the area with a predefined threshold.

This is because the encoder/decoder is generally unable to reconstruct large variations of short duration in the measurement series, due in particular to the loss of information resulting from the compression of information by the encoder part. In this case, the reconstructed current series is very different from the current measurement series during this short period of significant variations, resulting in high anomalies in the anomaly series, exceeding the detection threshold while the system is functioning normally. However, the measurements of many aircraft systems can show significant short-term variations, without this representing an anomaly, or a weak anomaly signal. For example, in the valves of a de-icing system, at the start of the pressure build-up, it is usual for the pressure measurements to instantly exceed the expected nominal values. However, the area separating the current distribution function from the reference distribution function will not be very sensitive to short duration variations, even large ones, precisely because they are of short duration. In this way, the invention allows the false anomaly detection to be avoided, which could occur by using a detection threshold.

The invention may also comprise one or more of the following advantageous characteristics, in any technically possible combination.

Advantageously, the system is configured to operate in several functioning configurations and the method further comprises:
selecting, from encoders/decoders respectively associated with the functioning configurations, the one associated with the functioning configuration in which the device was located during the current series of measurements.

Also advantageously, the encoder/decoder is a pre-trained learning system for reconstructing series of measurements acquired during normal functioning of the system.

Also advantageously, the encoder/decoder comprises an encoder neural network and a decoder neural network.

Also advantageously, the neural networks are two recurrent neural networks with long short-term memory.

Also advantageously, the system is a system for de-icing an air inlet lip, the de-icing system being configured to collect the hot air from a turbomachine, and comprising a channel for conveying the hot air to the air inlet lip and at least one valve on the conveying channel.

It is also advantageous for the de-icing system to comprise two valves in series on the conveying channel.

Also proposed is a computer program that can be downloaded from a communication network and/or recorded on a computer-readable medium, characterised in that it comprises instructions for executing the steps of a method according to the invention, when said computer program is executed on a computer.

A device for monitoring an aircraft system is also proposed, comprising:
a module for obtaining a series of measurements, called current series of measurements, of one or more physical quantities of the device, during a period of time when the device is functioning;
a module for using an encoder/decoder to provide a reconstructed series, called reconstructed current series, from the current series of measurements; and
a module for comparing the reconstructed current series with the current series of measurements in order to obtain a series of anomalies, called current series of anomalies;
   characterised by:
a module for computing a distribution function, called current distribution function, for the current series of anomalies;
a module for computing an area separating the current distribution function from a reference distribution function; and
a module for comparing the area with a predefined threshold.

### BRIEF DESCRIPTION OF THE FIGURES

The invention will be better understood with the aid of the following description, given only by way of example and made with reference to the attached drawings wherein:

FIG. 1 is a schematic functional view of an example of an aircraft in which the invention is implemented,

FIG. 2 is a functional view of an example of an encoder/decoder used in the aircraft shown in FIG. 1,

FIG. 3 is a functional view of an example of a device for monitoring a de-icing device of an air inlet lip of the aircraft,

FIG. 4 is a block diagram of an example of a method for monitoring the de-icing device,

FIG. 5 is a block diagram of a method of a method for configuring the monitoring device,

FIG. 6 is a graph illustrating a reference distribution function and several distribution functions computed by the monitoring device,

FIG. 7 is a graph illustrating an example of a current series of measurements, together with the reconstructed current series and the associated current series of anomalies, in the case of normal behaviour,

FIG. 8 is a graph illustrating an example of a current series of measurements, together with the reconstructed current series and the associated current series of anomalies, in the case of abnormal behaviour, and

FIG. 8 is a graph illustrating a reference distribution function and two distribution functions for FIGS. 7 and 8 respectively.

### DETAILED DESCRIPTION OF THE INVENTION

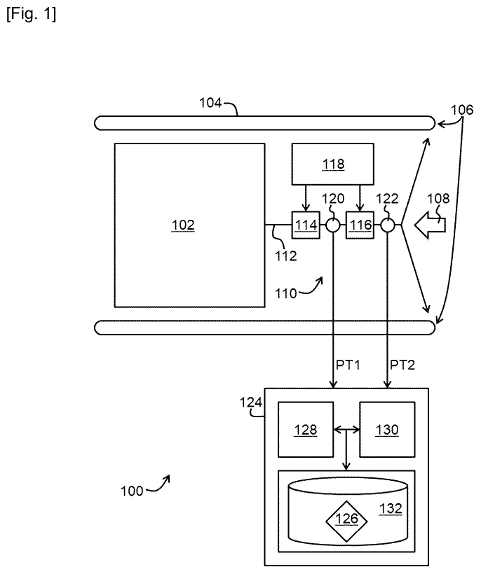

With reference to FIG. 1, an example of an aircraft 100 in which the invention is implemented will now be described.

The aircraft 100 firstly comprises a turbomachine 102.

The aircraft 100 also comprises a nacelle 104 surrounding the turbomachine 102. In particular, the nacelle 104 has an air inlet lip 106 delimiting an air inlet 108 for the turbomachine 102.

The aircraft 100 also comprises a system 110 for de-icing the air inlet lip 106. The de-icing system 110 is configured in particular to take hot air from the turbomachine 102, and comprises a channel 112 for conveying the hot air to the air inlet lip 106. The de-icing system 110 comprises, for example, a first valve 114 and a second valve 116 in series with each other on the conveying channel 112. This redundancy ensures the proper functioning of the de-icing system 110 in the event of failure of one of the two valves 114, 116. Each valve 114, 116 is configured to be selectively in an open state, in which the valve 114, 116 is configured to regulate the downstream pressure of the hot air (at the outlet of the valve in question) to a predefined regulation pressure, and in a closed state, in which the valve 114, 116 is configured to prevent the circulation of the hot air.

The aircraft 100 also comprises a device 118 for controlling the valves 114, 116.

The de-icing system 110 is thus configured to function in several functioning configurations, depending on the states in which the control device 118 places the valves 114, 116. In the first functioning configuration, known as “ON”, both valves 114, 116 are open. In the second functioning configuration, known as “OFF”, the valve 114 is closed, while the second valve 116 is open. In a third functioning configuration, known as “AUTOTEST”, the valves 114, 116 are tested at the start of a flight of the aircraft 100, when the pressure of the hot air upstream of the valves 114, 116 is low.

The aircraft 100 also comprises a first sensor 120 for the downstream pressure PT1 of the first valve 114 and a second sensor 122 for the downstream pressure PT2 of the second valve 116.

The aircraft 100 also includes a device 124 for monitoring the valves 114, 116 on the basis of the downstream pressures PT1, PT2.

In particular, the monitoring device 124 comprises at least one encoder/decoder type neural network 126. Preferably, an encoder/decoder 126 is provided for each configuration of the valves 114, 116.

Each encoder/decoder 126 comprises an encoder part and a decoder part. The encoder part is configured to perform a compression of the information provided to it as input in order to provide intermediate information that is incomplete as a result of the compression. The decoder part is configured to perform decompression, i.e. to reconstitute the input information from the incomplete intermediate information. In the example described, the input information consists of a time series of measurements of downstream pressures PT1, PT2. The decoder part is configured to provide a reconstructed time series. The encoder/decoder 126 is configured to function with series of measurements acquired during supposedly normal functioning of the valves 114, 116, i.e. in the absence of an anomaly. This means that it is configured so that the reconstructed series resembles the measurement series as closely as possible when the latter is acquired during supposedly normal functioning of the valves 114, 116.

The encoder/decoder 126 is, for example, a learning system. In this case, the encoder/decoder 126 is pre-trained on the basis of several series of measurements, called training series of measurements, all acquired during supposedly normal functioning of the valves 114, 116.

To obtain these drive series, it is possible, for example, to take series of measurements obtained during the functioning of the valves 114, 116 for which the times of failure of at least one of the valves 114, 116 or of maintenance of the valves 114, 116 are known. It can therefore be assumed that the valves 114, 116 were functioning normally and sufficiently before these times. In this way, the measurements prior to these instants of a predefined duration, for example one month, can be considered as acquired during normal functioning of the valves 114, 116, and used to obtain the training series.

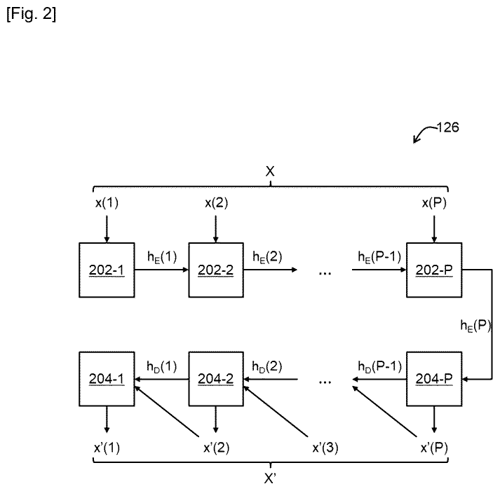

An example of an encoder/decoder 126 will be described in more detail with reference to FIG. 2.

The monitoring device 124 comprises, for example, a computer system comprising a data processing unit 128 (such as a microprocessor) and a main memory 130 (such as a Random Access Memory) accessible by the processing unit 128. The computer system also comprises, for example, a network interface and/or a computer-readable medium, such as a local medium (such as a local hard disk 132) or a remote medium (such as a remote hard disk accessible via the network interface through a communication network) or a removable medium (such as a Universal Serial Bus (USB) key, or a Compact Disc (CD) or a Digital Versatile Disc (DVD)) that can be read by an appropriate computer system drive (such as a USB port or a CD and/or DVD disk drive). A computer program 134 containing instructions for the processing unit 128 is stored on the medium 132 and/or can be downloaded via the network interface. This computer program 134 is, for example, intended to be loaded into the main memory 130 so that the processing unit 128 can execute its instructions. To make it easier to describe the computer program 132, the instructions will be described hereafter as organised into software modules. However, this presentation does not prejudge the form of the computer program 132, which can be any form. In particular, the encoder/decoder 126 may be implemented in the form of a software module of the computer program 132.

Alternatively, all or some of these modules could be implemented in the form of hardware modules, i.e. in the form of an electronic circuit, for example micro-wired, not involving a computer program.

With reference to FIG. 2, an example of the encoder/decoder 126 will now be described.

The encoder/decoder 126 is configured to receive a series of measurements X grouping together P measurements x(1) . . . x(p) . . . x(P) taken at respective measurement times marked by the index p ranging from 1 to P. The measurements x(p) may be one-dimensional (a single physical quantity measured at each measurement time) or multi-dimensional (several physical quantities measured at each measurement time). In the example described, each measurement x(p) groups together a measurement of the downstream pressure PT1 and a measurement of the downstream pressure PT2 at the measurement time in question. The series of measurements X can therefore be written as:

$$X = [ \begin{matrix}x ( 1 ) & \begin{matrix}… & x ( P )\end{matrix}\end{matrix} ] = [ \begin{matrix}PT 1 ( 1 ) & … & PT 1 ( P ) \\ PT 2 ( 1 ) & … & PT 2 ( P )\end{matrix} ] \qquad [ Math . 1 ]$$

The encoder/decoder 126 is configured to provide a reconstructed series X′ from the series of measurements X. Thus, in the example described, the reconstructed series X′ can be written as:

$${X}^{′} = [ \begin{matrix}{x}^{′} ( 1 ) & \begin{matrix}… & {x}^{′} ( P )\end{matrix}\end{matrix} ] = [ \begin{matrix}PT {1}^{′} ( 1 ) & … & PT {1}^{′} ( P ) \\ PT {2}^{′} ( 1 ) & … & PT {2}^{′} ( P )\end{matrix} ] \qquad [ Math . 2 ]$$

The encoder/decoder 126 comprises, for example, an encoder neural network 202 and a decoder neural network 204 implementing the encoder part and the decoder part respectively.

The neural networks 202, 204 are, for example, two recurrent neural networks for long short-term memory (also known by the acronym LSTM).

In this case, the encoder neural network 202 may comprise P successive units 202-1 . . . 202-p . . . 202-P, each of which is configured to compute an internal value h_{E}(1) . . . h_{E}(p) . . . h_{E}(P) from a respective one of the measurements x(1) . . . x(p) . . . x(P), the internal value of the preceding unit and parameters of the unit under consideration. Each unit 202-p has, for example, the architecture described in https://fr.wikipedia.org/wiki/Réseau_de_neurones_récurrents, so that each internal value h_{E}(p) is obtained, for example, from the following equations:

$${h}_{E} ( t ) = {{o}_{E} ( t )}^{∘} {σ}_{h} ( {c}_{E} ( t ) ) \qquad [ Math . 3 ]$$

$${o}_{E} ( t ) = {σ}_{g} ( {W}_{E}^{o} x ( t ) + {U}_{E}^{o} {h}_{E} ( t - 1 ) + {b}_{E}^{o} )$$

$${c}_{E} ( t ) = {{f}_{E} ( t )}^{∘} {c}_{E} ( t - 1 ) + {{i}_{E} ( t )}^{∘} {\check{c}}_{E} ( t )$$

$${f}_{E} ( t ) = {σ}_{g} ( {W}_{E}^{f} x ( t ) + {U}_{E}^{f} {h}_{E} ( t - 1 ) + {b}_{E}^{f} )$$

$${i}_{E} ( t ) = {σ}_{g} ( {W}_{E}^{i} x ( t ) + {U}_{E}^{i} {h}_{E} ( t - 1 ) + {b}_{E}^{i} )$$

$${\check{c}}_{E} ( t ) = {σ}_{h} ( {W}_{E}^{c} x ( t ) + {U}_{E}^{c} {h}_{E} ( t - 1 ) + {b}_{E}^{c} )$$

where ○ denotes the Hadamard matrix product, σ_{g} denotes the sigmoid function, σₕ denotes the hyperbolic tangent function, f_{E}(t) denotes the activation state of the encoder's forget gate, i_{E}(t) denotes the activation state of the encoder's input gate, o_{E}(t) denotes the activation state of the encoder's output gate, c̆_{E}(t) denotes the activation state of the encoder's input cell, and c_{E}(t) denotes the internal state of the encoder's cell.

The decoder neural network 204 similarly comprises P successive units 204-1 . . . 204-p . . . 204-P. Each unit is configured to compute an internal value h_{D}(1) . . . h_{D}(p) . . . h_{D}(P) and a reconstructed value x′(1) . . . x′(p) . . . x′(P) from parameters and, except for the last unit 204-P, from the internal value h_{D}′(p+1) and the reconstructed value x′(p+1) of the next unit. Each unit 204-p has, for example, the architecture described in https://fr.wikipedia.org/wiki/Réseau_de_neurones_récurrents, so that each internal value h_{E}(p) is obtained, for example, from the following equations:

$${x}^{′ ( t )} = {{o}_{D} ( t )}^{∘} {σ}_{h} ( {c}_{D} ( t ) ) \qquad [ Math . 3 ]$$

$${o}_{D} ( t ) = {σ}_{g} ( {W}_{D}^{o} {h}_{E} ( P ) + {U}_{D}^{o} {x}^{′ ( t - 1 )} + {b}_{D}^{o} )$$

$${c}_{D} ( t ) = {{f}_{D} ( t )}^{∘} {c}_{D} ( t - 1 ) + {{i}_{D} ( t )}^{∘} {\check{c}}_{D} ( t )$$

$${f}_{D} ( t ) = {σ}_{g} ( {W}_{D}^{f} {h}_{E} ( P ) + {U}_{D}^{f} {x}^{′ ( t - 1 )} + {b}_{D}^{f} )$$

$${i}_{D} ( t ) = {σ}_{g} ( {W}_{D}^{i} {h}_{E} ( P ) + {U}_{D}^{i} {x}^{′ ( t - 1 )} + {b}_{D}^{i} )$$

$${\check{c}}_{D} ( t ) = {σ}_{h} ( {W}_{D}^{c} {h}_{E} ( P ) + {U}_{D}^{c} {x}^{′ ( t - 1 )} + {b}_{D}^{c} )$$

where º denotes the Hadamard matrix product, a denotes the sigmoid function, σₕ denotes the hyperbolic tangent function, f_{D}(t) denotes the activation state of the decoder's forget gate, i_{D}(t) denotes the activation state of the decoder's input gate, o_{D}(t) denotes the activation state of the decoder's output gate, c̆_{D}(t) denotes the activation state of the decoder's input cell, c_{D}(t) denotes the internal state of the decoder's cell, and W, U and b denote the decoder's weight matrices and bias parameters.

The internal value h_{D}(P) for the last unit 204-P of the decoder neural network 204 is taken to be equal to the internal value h_{E}(P) of the last unit 202-P of the encoder neural network 202. This internal value h_{E}(P)=h_{D}(P) therefore forms the compressed intermediate information of the encoder/decoder 126.

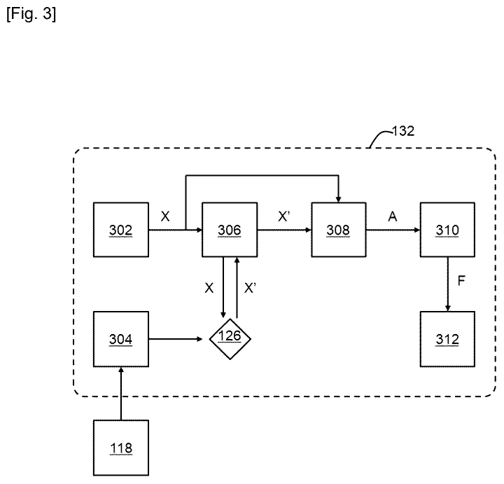

With reference to FIG. 3, an example of the computer program 132 will now be described.

The computer program 132 comprises a module 302 configured to obtain a series of measurements, called current series of measurements X, of one or more physical quantities of the de-icing system 110, during a period of time when the de-icing system 110 is functioning in one of its functional configurations. In this way, a value for the or each physical quantity is obtained for each of several successive measurement times p. More specifically, in the example shown, the physical quantities are the downstream pressures PT1, PT2 provided by the sensors 120, 122.

The computer program 132 also comprises a module 304 configured to select the encoder/decoder 126 associated with the functioning configuration, called current functioning configuration, in which the de-icing system 110 was during the measurement times p. For example, the module 304 is configured to receive an indication of the functioning configuration from the control device 118.

The computer program 132 also comprises a module 306 configured to use the encoder/decoder 126 selected by the module 304, to obtain a reconstructed series, called reconstructed current series X′, from the current series of measurements X.

The computer program 132 also comprises a module 308 configured to compare the current reconstructed series X′ with the current series of measurements X, in order to obtain a series of anomalies, called current series of anomalies A, representing anomalies in the reconstructed current series X′ with respect to the current series of measurements X.

For example, the module 308 is configured to first compute, at each measurement time p, an error e(p) between the measurement x(p) at that measurement time p of the current series of measurements X and the reconstructed value x′(p) at that measurement time p of the reconstructed current series X′, for example by:

$$e ( p ) = \vert x ( p ) - {x}^{′} ( p ) \vert \qquad [ Math . 3 ]$$

where | . . . | is the absolute value function.

The module 308 is also configured, for example, to compute, at each measurement time p, an anomaly a(p) (also called an “anomaly score”) from the error e(p) at that measurement time p. The anomalies a(p) computed in this way form the anomaly series A.

For example, the errors e(p) are assumed to follow a predefined probability distribution, characterised by one or more parameters. These parameters comprise, for example, a mean μ and/or a standard deviation Σ. The probability distribution is, for example, a normal distribution. In this way, the anomalies a(p) can define a distance from what is expected by the probability law, using the parameter(s) of this probability law.

For example, particularly in the case of the normal distribution, the anomaly a(p) can be computed from the mean μ and standard deviation Σ of the probability distribution, by:

$$a ( p ) = {( e ( p ) - μ )}^{T} {Σ}^{- 1} ( e ( p ) - μ ) \qquad [ Math . 4 ]$$

The computer program 132 also comprises a module 310 configured to compute a cumulative distribution function F of the anomalies a(p). The cumulative distribution function is also called the distribution function.

To do this, the module 310 is preferably configured to compute a predefined number N (for example one thousand, so as to have a sufficiently accurate approximation) of anomaly values a₁ . . . aₙ . . . a_{N} equidistant between zero and the maximum anomaly a(p). The module 310 is then configured to compute the number of anomaly values aₙ less than or equal to a, for several values of a, for example by the following formula:

$$F ( a ) = {\sum }_{n = 1}^{N} {1}_{[ \begin{matrix}- ∞ , & a\end{matrix} ]} ( {a}_{n} ) \qquad [ Math . 5 ]$$

where 1_{[-∞, a]}(aₙ) is one when aₙ is in the interval [−∞, a] and zero otherwise.

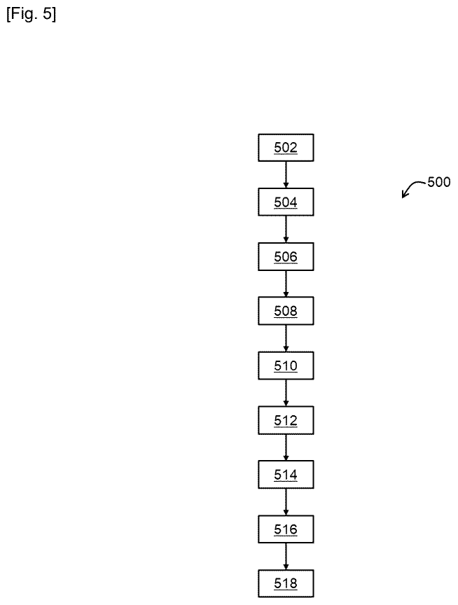

The computer program 132 also comprises a module 312 configured to compute an area separating the cumulative distribution function F from a reference cumulative distribution function Fₛ, expected in the absence of anomalies. An example of how to obtain the reference cumulative distribution function Fₛ will be described later with reference to FIG. 5. Preferably, a reference distribution function Fₛ is provided for each functioning configuration, and the comparison is made with that associated with the current functioning configuration.

Preferably, the module 312 is also configured to normalise the computed area A. For example, this normalisation comprises dividing the area A by the area under the reference distribution function Fₛ (i.e. the area between the x-axis and the reference distribution function Fₛ).

The computer program 132 also comprises a module 314 configured to detect an anomaly as a function of the comparison.

More specifically, the computed area is compared with a predefined threshold and, if the area is greater than this threshold, an anomaly is detected. If the area is below this threshold, no anomaly is detected.

It is also possible to provide several thresholds to distinguish a low-level anomaly (area greater than the lowest threshold) from a high-level anomaly (area greater than the highest threshold).

An anomaly detected, for example, is examined by an engineer who can then send a report to the airline using the aircraft to warn it. The airline can then carry out a maintenance operation on valves 114 and 116, to repair or replace them.

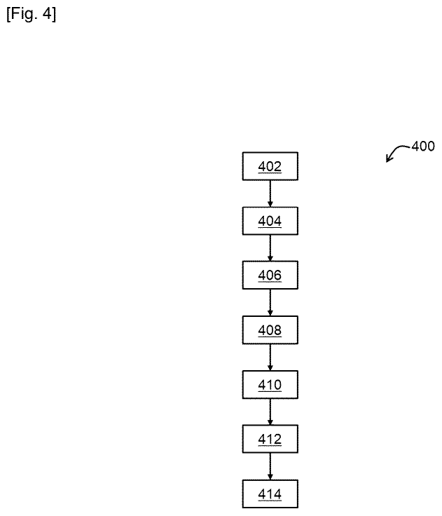

With reference to FIG. 4, an example of a method 400 for monitoring the de-icing system 110 will now be described.

In a step 402, the module 302 obtains a current series of measurements X taken while the de-icing system 110 is functioning in one of its functioning configurations, referred to as the current functioning configuration.

In a step 404, the module 304 selects the encoder/decoder 126 associated with the current functioning configuration.

In a step 406, the module 306 uses the selected encoder/decoder 126 to obtain a reconstructed current series X′ from the current series of measurements X.

In a step 408, the module 308 compares the reconstructed current series X′ with the current series of measurements X, in order to obtain a current anomaly series A.

In a step 410, the module 310 computes the cumulative distribution function F of the current anomaly series A.

In a step 412, the module 312 computes the area A separating the cumulative distribution function F from the reference cumulative distribution function Fₛ.

In a step 414, the module 314 detects an anomaly by comparing the computed area with the predefined threshold.

With reference to FIG. 5, an example of a method 500 for configuring the monitoring device 124 will now be described.

For example, the following steps are carried out for each functioning configuration of the de-icing system 110.

During a step 502, several series of measurements, called training series of measurements X*, are obtained, while the de-icing system 110 is functioning normally. For example, each training series X* comprises P measurements.

In a step 504, an encoder/decoder 126 is trained from the training series X*, in order to provide reconstructed series X′* which are respectively as close as possible to the training series X*.

During a step 506, several series of measurements, called initialisation series of measurements X○, are obtained, while the de-icing system 110 is functioning normally. Preferably, the initialisation series X○ are different from the training series X*. The initialisation series X○ each comprise, for example, P measurements.

In a step 508, the driven encoder/decoder 126 is used to provide reconstructed series X○′ from the initialization series X○.

During a step 510, for each initialisation series X○, an error series E○ is computed between the initialisation series X○ and the corresponding reconstructed series X○′.

Each error series E○ comprises, for each measurement instant p, an error e○(p) between the measurement x○(p) at that measurement instant p of the initialization series X○ and the reconstructed value x○′(p) at that measurement instant p of the reconstructed series X○′, for example according to the previous equation [Math. 3].

In a step 512, one or more parameters of a probability law that these error series E○ are supposed to follow are computed from the error series E○. For example, the error series E○ can be assumed to follow a normal distribution characterised by a mean μ and a standard deviation Σ. Thus, the mean μ and/or the standard deviation Σ can be computed from the error series E○. This can be done using Maximum Likelihood Estimation (MLE).

In a step 514, for each error series E○, an anomaly series A○ is computed from the mean μ and the standard deviation Σ, for example according to the previous formula [Math. 4].

In a step 516, for each series of anomalies A○, a distribution function, called healthy distribution function F○, of the series of anomalies A○ under consideration is computed, for example according to the previous formula [Math. 5].

In a step 518, the reference distribution function Fs is computed from the distribution functions F○, for example by averaging them.

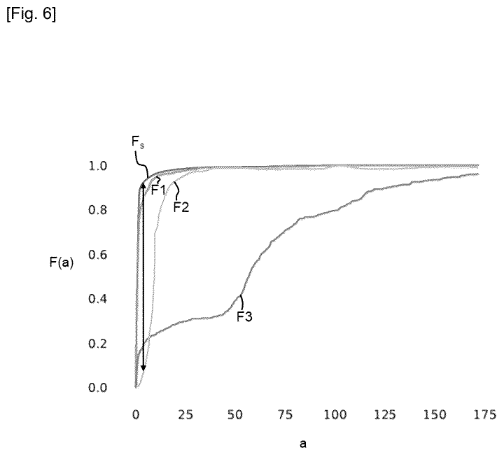

With reference to FIG. 6, an example of a reference distribution function Fs and several examples of distribution functions F1, F2, F3 are illustrated.

The distribution function F1 corresponds to a normal functioning of the valves 114, 116 and is therefore very close to the reference distribution function Fs, so that the area separating them is very small.

On the other hand, the distribution function F3 corresponds to abnormal operation of the valves 114, 116 and is therefore very different from the reference distribution function Fs, so that the area separating them is very large.

The distribution function F2 corresponds to a normal functioning of valves 114, 116, but with small errors (i.e. for the small values of a). Such small errors can occur discreetly but frequently because of the aircraft's environment, which can be very noisy at times. By considering the area between the curves, it is possible to correctly classify the operation of valves 114, 116 as normal. This might not have been the case if the criterion had been, for example, a classic criterion of the greatest vertical difference between the curves. In the latter case, because of the small errors, this greater vertical distance (represented by the double arrow in FIG. 6) would be very high.

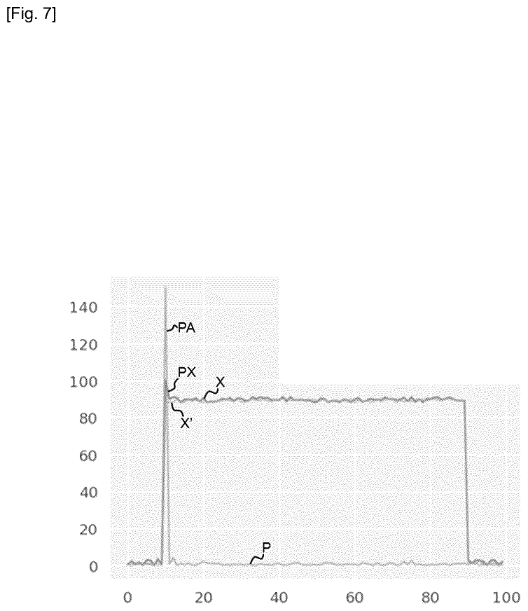

With reference to FIG. 7, an example of a current series of measurements X is illustrated (time on the x-axis, measurement on the ordinate), together with the reconstructed current series X′ and the associated current series of anomalies A, for normal behaviour of the valve 114 or 116. As can be seen, the current series of measurements X comprises an initial peak PX, corresponding, for example, to the rise in pressure of the valve 114 or 116 following its opening. However, because the encoder/decoder 126 is unable to reconstruct this peak PX, the reconstructed current series X′ does not comprise a corresponding peak, so that the current series of anomalies A comprises a peak PA at the time of the peak PX.

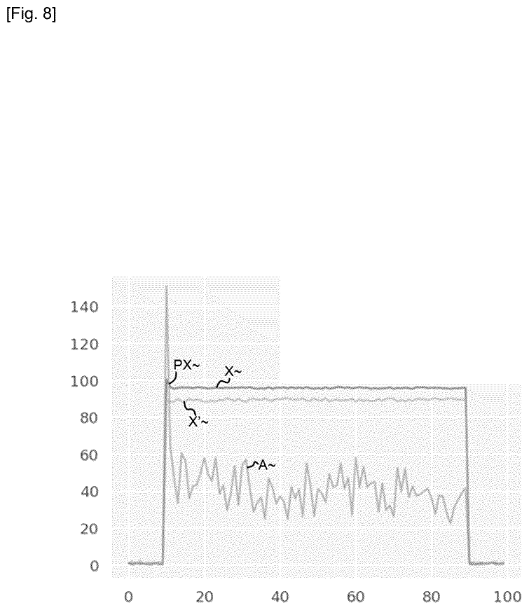

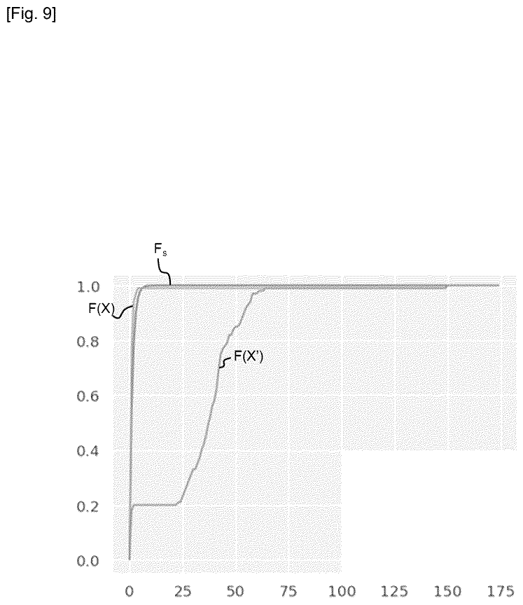

Using a low detection threshold (e.g. 110), all the time series exhibiting the behaviour illustrated would be considered abnormal, whereas the system (the valve 114 or 116) is functioning normally. Conversely, if a high threshold is chosen (e.g. 160), it will not allow the detection of abnormal behaviour. To illustrate this, FIG. 8 shows a current series of measurements X˜ (time on the X-axis, measurement on the ordinate) with an initial peak PX˜, as well as the reconstructed current series X′˜ and the associated current series of anomalies A˜, for an abnormal behaviour of the valve 114 or 116. Because the behaviour is abnormal, the reconstructed current series X′˜ is slightly offset from the current series of measurements X′˜. This slight offset is sometimes called a “small drift”. Thus, the anomalies in the series of anomalies, after the initial peak PA˜, are slightly greater than zero. To detect the slight drift, a relatively low threshold would have to be used, which would lead to false detections of abnormality because of the initial peak PA˜. On the contrary, a high threshold, higher than the initial peak PA˜, would not allow the detection of the small drift.

Thus, with a detection threshold directly applied to the current series of anomalies, due to the presence of the initial peak, either abnormal behaviour would be deduced from almost all the current series of measurements, or healthy behaviour, depending on the detection threshold chosen. In both cases, it's not satisfactory.

With reference to FIG. 9, a reference distribution function FS is illustrated, with the distribution function F(X) for the current series of measurements X in FIG. 7 and the distribution function F(X˜) for the current series of measurements X˜ in FIG. 8. As can be seen, the presence of the initial PX peak does not change the distribution function F(X) much compared with the reference distribution function Fₛ, leading to a very small difference in area. On the other hand, the distribution function F(X′) is very different from the reference distribution function Fₛ, leading to a high difference in area. In this way, it is possible to distinguish the normal behaviour of FIG. 7 from the abnormal behaviour of FIG. 8, which would not be possible using a detection threshold on the current series of anomalies A, A˜.

In conclusion, it should be noted that the invention is not limited to the embodiments described above. In fact, it will appear to the person skilled in the art that various modifications can be made to the above-described embodiments, in the light of the teaching just disclosed.

In the foregoing detailed presentation of the invention, the terms used should not be interpreted as limiting the invention to the embodiments exposed in the present description, but should be interpreted to include all equivalents the anticipation of which is within the reach of the person skilled in the art by applying his general knowledge to the implementation of the teaching just disclosed.

1. A method for detecting an anomaly in a system of an aircraft, comprising:
obtaining a series of measurements, called current series of measurement, of one or more physical quantities of the system, during a period of time when the system is functioning;
on the basis of the current series of measurements, providing by an encoder/decoder a reconstructed series, called reconstructed current series; and
comparing the reconstructed current series with the current series of measurements in order to obtain a series of anomalies, called current series of anomalies;
wherein:
computing a distribution function, called current distribution function, of the current series of anomalies;
computing an area separating the current distribution function from a reference distribution function; and
comparing the area with a predefined threshold.

2. The method according to claim 1, wherein the system is configured to operate in several functioning configurations and further comprising:
selecting, from encoders/decoders respectively associated with the functioning configurations, the one associated with the functioning configuration in which the device was during the current series of measurements.

3. The method according to claim 1, wherein the encoder/decoder is a pre-trained learning system for reconstructing series of measurements acquired during normal functioning of the system.

4. The method of claim 3, wherein the encoder/decoder comprises an encoder neural network and a decoder neural network.

5. The method according to claim 4, wherein the neural networks are two recurrent neural networks with long short-term memory.

6. The method according to claim 1, wherein the system is a system for de-icing an air inlet lip, the de-icing system being configured to collect the hot air from a turbomachine, and comprising a channel for conveying the hot air to the air inlet lip and at least one valve on the conveying channel.

7. The method according to claim 6, wherein the de-icing system comprises two valves in series on the conveying channel.

8. A computer program downloadable from a communications network and/or recorded on a computer-readable medium, wherein it comprises instructions for executing the steps of a method according to claim 1, when said computer program is executed on a computer.

9. A device for monitoring a system of an aircraft, comprising:
a module for obtaining a series of measurements, called current series of measurement, of one or more physical quantities of the device, during a period of time when the device is functioning;
a module for using an encoder/decoder to provide a reconstructed series, called reconstructed current series, from the current series of measurements; and
a module for comparing the reconstructed current series with the current series of measurements order to obtain a series of anomalies, called current series of anomalies;
wherein:
a module for computing a distribution function, called current distribution function, of the current series of anomalies;
a module for computing an area separating the current distribution function from a reference distribution function; and
a module for comparing the area with a predefined threshold.
